(19) United States
(12) Patent Application Publication
(10) Pub. No.: US 2008/0319708 A1
(43) Pub. Date: Dec. 25, 2008

(54) Apparatus and Method For Estimating Virtual Axis Magnetic Compass Data to Compensate the Tilt Error of Biaxial Magnetic Compass, and Apparatus For Calculating Azimuth Based on the Same

(75) Inventor: Seong-Yun Cho, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/093,092

(22) PCT Filed: Dec. 21, 2005
(86) PCT No.: PCT/KR05/04426

§ 371 Date: May 8, 2008

(30) Foreign Application Priority Data
Nov. 8, 2005 (KR) 10-2005-0106553

(51) Int. Cl. G01C 9/00

(52) U.S. Cl. 702/154

(57) ABSTRACT

Provided is an apparatus for estimating virtual axis geomagnetic data using a 2-axis geomagnetic sensor and an inclinometer, including a geomagnetic data normalizing unit for normalizing 2-axis geomagnetic data measured by the 2-axis geomagnetic sensor, a tilt angle calculator for calculating a tilt angle of the 2-axis geomagnetic sensor by using tilt information measured by the inclinometer, and a virtual axis geomagnetic data estimator for determining a magnitude of virtual geomagnetic data with respect to a virtual axis by using the normalized 2-axis geomagnetic data, and determining a sign of the virtual geomagnetic data based on the normalized 2-axis geomagnetic data, the calculated tilt angle and a dip angle to thereby estimate the virtual geomagnetic data.

### TECHNICAL FIELD

The present invention relates to an apparatus and a method for estimating virtual axis geomagnetic data to compensate a tilt angle error of 2-axis (x-axis and y-axis) geomagnetic sensor, and an apparatus for calculating an azimuth angle using the same. More particularly, the present invention relates to an apparatus and a method capable of estimating virtual z-axis geomagnetic sensor data without being affected by a tilt angle error or a dip angle error, and calculating an error-compensated accurate azimuth angle based on the estimated data, in case of estimating z-axis geomagnetic sensor data by using a 2-axis geomagnetic sensor and an inclinometer and calculating an azimuth angle based the estimated data.

### BACKGROUND ART

Azimuth information has been mainly used in navigation devices; and, in recent years, such information has been needed in mobile terminals such as a cellular phone, PDA, and the like for various purposes. For providing the azimuth information, a gyro, a geomagnetic sensor, etc. have been utilized. Among them, the geomagnetic sensor is frequently used for calculating absolute azimuth information. Such a geomagnetic sensor is a device for measuring the strength of the earth's magnetic field to calculate an azimuth angle. A 2-axis geomagnetic sensor is adopted in a device in which a horizontal plane is maintained, while a 3-axis geomagnetic sensor is arranged in a device in which a horizontal plane is not maintained. This is because the 3-axis geomagnetic sensor is required to correct a pose angle (a roll angle or a pitch angle) error and calculate the azimuth angle when the pose angle is not “0”.

On the other hand, the mobile terminal should incorporate therein the 2-axis geomagnetic sensor due to its size limitation although the horizontal plane is not maintained. Therefore, there has been a need for a scheme of compensating a tilt angle error of the 2-axis geomagnetic sensor.

For the tilt angle error compensation of the 2-axis geomagnetic sensor, a study has been made on a method of estimating a virtual z-axis geomagnetic sensor signal.

One of conventional methods for estimating the virtual z-axis geomagnetic sensor signal is disclosed in Korean Laid-open Publication No. 10-2004-0013439 (Laid-open Publication Date: Feb. 14, 2004), entitled “Apparatus and Method for Compensating Pose Error of Geomagnetic Sensor”.

In such a method, the virtual z-axis geomagnetic sensor data, that is, a magnitude and a sign thereof are estimated through an equation having roll and pitch angles as variables. However, the conventional method has a drawback that an error is involved in estimated data owing to a tilt angle error or a dip angle error. Consequently, a need has existed for a technique capable of estimating z-axis geomagnetic sensor data without being affected by the above errors and calculating an exact azimuth angle with no error based on the estimated data.

### DISCLOSURE

### Technical Problem

It is, therefore, an object of the present invention to provide an apparatus and a method for estimating virtual axis geomagnetic data to compensate a tilt angle error of 2-axis (x-axis and y-axis) geomagnetic sensor, and an apparatus for calculating an azimuth angle using the same, which are capable of estimating virtual z-axis geomagnetic sensor data without being affected by a tilt angle error or a dip angle error by obtaining a magnitude and a sign of the sensor data separately, and calculating an error-compensated accurate azimuth angle based on the estimated data, in case of estimating z-axis geomagnetic sensor data by using a 2-axis geomagnetic sensor and an inclinometer and calculating an azimuth angle based the estimated data.

### Technical Solution

In accordance with one aspect of the present invention, there is provided an apparatus for estimating virtual axis geomagnetic data using a 2-axis geomagnetic sensor and an inclinometer, including: a geomagnetic data normalizing unit for normalizing 2-axis geomagnetic data measured by the 2-axis geomagnetic sensor; a tilt angle calculator for calculating a tilt angle of the 2-axis geomagnetic sensor by using tilt information measured by the inclinometer; and a virtual axis geomagnetic data estimator for determining a magnitude of virtual geomagnetic data with respect to a virtual axis by using the normalized 2-axis geomagnetic data, and determining a sign of the virtual geomagnetic data based on the normalized 2-axis geomagnetic data, the calculated tilt angle and a dip angle to thereby estimate the virtual geomagnetic data.

In accordance with another aspect of the present invention, there is provided a method for estimating virtual z-axis geomagnetic sensor data in a mobile terminal incorporating a 2-axis geomagnetic sensor and an inclinometer, including the steps of: measuring, at the 2-axis geomagnetic sensor, x-axis and y-axis directional geomagnetic data (2-axis geomagnetic data) when the mobile terminal rotates about z-axis; normalizing the 2-axis geomagnetic data by using maximum and minimum values among the measured geomagnetic data, and a dip angle; calculating a pitch angle and a roll angle of the 2-axis geomagnetic sensor based on tilt information measured by the inclinometer; estimating a magnitude of the virtual z-axis geomagnetic data from the normalized 2-axis geomagnetic data; and estimating a sign of the virtual z-axis geomagnetic data depending on the normalized 2-axis geomagnetic data, the dip angle, and the pitch and roll angles obtained at the calculating step.

In accordance with still another aspect of the present invention, there is provided an apparatus for calculating an azimuth angle using a 2-axis geomagnetic sensor, including: a virtual axis geomagnetic data estimator for determining a magnitude of geomagnetic data with respect to a virtual axis by using 2-axis geomagnetic data measured and normalized by the 2-axis geomagnetic sensor, and determining a sign of the virtual axis geomagnetic data based on the normalized 2-axis geomagnetic data, a tilt angle and a dip angle of the 2-axis geomagnetic sensor to thereby estimate the virtual axis geomagnetic data; and an azimuth angle calculator for calculating an azimuth angle by using the normalized 2-axis geomagnetic data, the tilt angle, and the virtual axis geomagnetic data estimated by the virtual axis geomagnetic data estimator.

As mentioned above, the present invention determines the magnitude of the z-axis geomagnetic sensor data based on the fact that Euclidean distance of 3-axis geomagnetic sensor data is 1, and also determines the sign thereof separately, thereby estimating accurate z-axis geomagnetic sensor data. Unlike the existing methods, no error is occurred in the data so estimated although there are an inclinometer error and a dip angle estimation error. Therefore, it is possible to calculate the accurate azimuth information, which the tilt angle error is compensated, with only the 2-axis geomagnetic sensor. In other words, the present invention provides a technology capable of calculating the accurate azimuth angle by efficiently correcting the tilt angle error of the 2-axis geomagnetic sensor module that may be embedded in the mobile terminal that needs the azimuth information.

The other objectives and advantages of the invention will be understood by the following description and will also be appreciated by the embodiments of the invention more clearly. Further, the objectives and advantages of the invention will readily be seen that they can be realized by the means and its combination specified in the claims.

### Advantageous Effects

As mentioned above and below, the present invention has an advantage in that it can compensate a tilt angle error of the 2-axis geomagnetic sensor, which may happen in estimating virtual z-axis geomagnetic sensor data.

In addition, the present invention enables a mobile terminal employing a 2-axis geomagnetic sensor, not a 3-axis geomagnetic sensor, due to its size limitation to have the same performance as the one employing the 3-axis geomagnetic sensor.

Furthermore, since azimuth information calculated by the 2-axis geomagnetic sensor embedded in the mobile terminal is exact azimuth information that the tilt angle error is compensated, it can be used for various purposes such as a Mecca indication, a direction search in a mountain, an input value for game, and navigation, etc.

### DESCRIPTION OF DRAWINGS

The above and other objects and features of the present invention will become apparent from the following description of the preferred embodiments given in conjunction with the accompanying drawings, in which:

FIG. 1 shows a configuration of a system for providing azimuth information in a mobile terminal in accordance with an embodiment of the present invention;

FIG. 2 is a block diagram of an apparatus for estimating virtual axis geomagnetic data to compensate a tilt angle error of a 2-axis geomagnetic sensor and an apparatus for calculating an azimuth angle using the same in accordance with an embodiment of the present invention;

FIG. 3 illustrates z-axis geomagnetic sensor data with respect to a pitch angle and an azimuth angle;

FIG. 4 is a block diagram showing a configuration of an experimental device for analyzing the performance of an azimuth angle calculating apparatus in accordance with an embodiment of the present invention;

FIG. 5 presents a variable amount of a tilt angle used as an input variable in the experimental device shown in FIG. 4;

FIG. 6 describes the comparison result of estimation values of the z-axis geomagnetic sensor data between the conventional method and the present invention;

FIG. 7 depicts the comparison result of estimation errors of the z-axis geomagnetic sensor data between the conventional method and the present invention; and

FIG. 8 provides the comparison result of azimuth angle errors between the conventional method and the present invention.

### BEST MODE FOR THE INVENTION

The above-mentioned objectives, features, and advantages will be more apparent by the following detailed description in association with the accompanying drawings; and thus, the invention will be readily conceived by those skilled in the art to which the invention pertains. Further, in the following description, well-known arts will not be described in detail if it seems that they could obscure the invention in unnecessary detail. Hereinafter, preferred embodiments of the present invention will be set forth in detail with reference to the accompanying drawings.

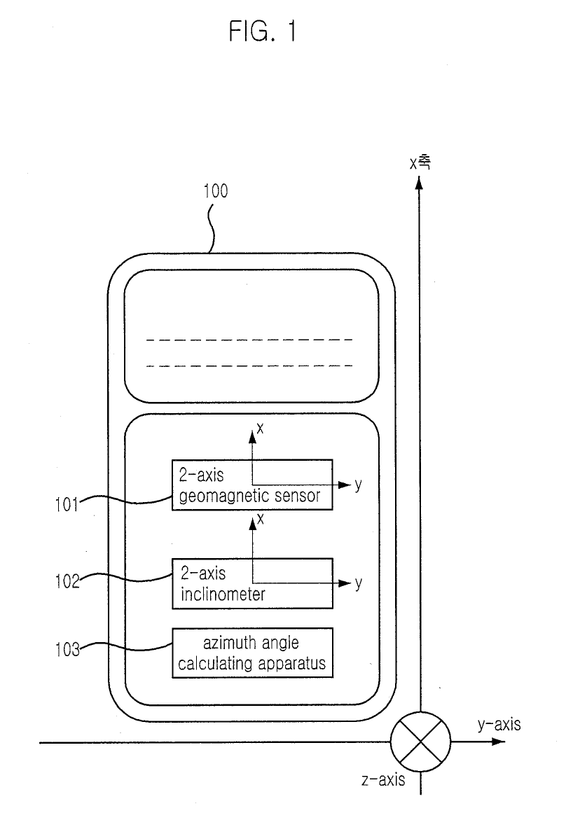

FIG. 1 shows a configuration of a system for providing azimuth information in a mobile terminal in accordance with an embodiment of the present invention.

As shown in FIG. 1, the inventive system for providing azimuth information is embedded in a mobile terminal 100 and includes a 2-axis geomagnetic sensor 101, a 2-axis inclinometer 102 and an azimuth angle calculating apparatus 103.

The mobile terminal 100 indicates all mobile devices requiring azimuth information, like a cellular phone, a PDA, a game player, a mobile navigation device, etc.

A coordinate system for measuring an azimuth angle is defined in the mobile terminal 100. As shown in FIG. 1. an upper direction of the mobile terminal 100 is defined as x-axis, and a right direction perpendicular to the x axis as y-axis; and a rear direction of the mobile terminal 100, namely, a direction penetrating into the paper is defined as z axis according to the right hand law.

Here, the 2-axis geomagnetic sensor 101 is a geomagnetic sensor whose 2 axes are arranged to be perpendicular to each other and may be any type of geomagnetic sensor among a fluxgate, a Magneto-Resistive (MR) sensor, a Magneto-inductive (MI) sensor and so on. With regard to arrangement of the 2-axis geomagnetic sensor in the mobile terminal 100, an x-axis geomagnetic sensor is arranged on an upper side of the mobile terminal 100, while a y-axis geomagnetic sensor is provided on a right side thereof and perpendicularly to the x-axis.

The 2-axis inclinometer 102 is for measuring a tilted angle of the 2-axis geomagnetic sensor 101 with respect to a horizontal plane (the earth's surface), that is, a tilt (a roll angle and a pitch angle); and is arranged along 2 axes perpendicular to each other. Here, the inclinometer 102 may be any one of an accelerometer sensor and the like. Regarding arrangement of the 2-axis inclinometer in the mobile terminal 100, an x-axis inclinometer is arranged in the same direction as the x-axis geomagnetic sensor, whereas a y-axis inclinometer is arranged in the same direction as the y-axis geomagnetic sensor.

The azimuth angle calculating apparatus 103 is a microprocessor for processing sensor data, compensating the tilt angle error and finally calculating the azimuth angle.

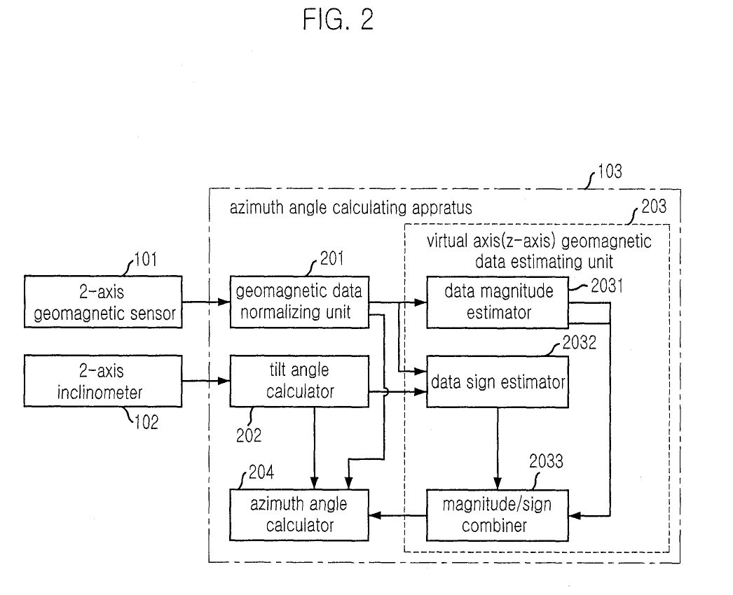

FIG. 2 exemplifies a detailed block diagram of the apparatus for estimating virtual axis geomagnetic data to compensate a tilt angle error of the 2-axis geomagnetic sensor and the apparatus for calculating the azimuth angle using the same in accordance with an embodiment of the present invention.

In FIG. 2, the apparatus for estimating virtual axis geomagnetic data to compensate the tilt angle error of the 2-axis geomagnetic sensor includes devices designated by reference numerals 201 through 203; and the apparatus 103 for calculating the azimuth angle includes devices indicated by reference numerals 201 through 204. Hereinafter, the virtual axis geomagnetic data estimating apparatus and the azimuth angle calculating apparatus using the same will be described in detail in parallel with a method for estimating the virtual axis geomagnetic data.

The azimuth angle of the mobile terminal 100 indicates an angle between a projection line on the horizontal plane at the x-axis and a magnetic north. Before calculating the azimuth angle, the 2-axis geomagnetic sensor data and the 2-axis inclinometer data are first normalized.

The process of normalizing the 2-axis geomagnetic sensor data is performed in the geomagnetic data normalizing unit 201 as follows.

First of all, when a user puts the mobile terminal 100 on the horizontal plane (a plane horizontal with respect to the earth's surface) and then rotates the mobile terminal by 360° or more about the z-axis, the x-axis and y-axis geomagnetic sensor data (2-axis geomagnetic data) are measured during the rotation and then input to the geomagnetic data normalizing unit 201.

If the maximum values and minimum values among the input x-axis and y-axis geomagnetic sensor data measured during the mobile terminal's rotation of 360° are referred to as [xₘᵢₙ, xₘₐₓ] and [yₘᵢₙ, yₘₐₓ], respectively, each normalized axial value (normalized 2-axis geomagnetic data) of the geomagnetic sensor can be obtained by using the following:

$${\overline{X}}_{mc} = ( {C}_{mc} - \frac{{x}_{max} + {x}_{min}}{2} ) \frac{2 cos λ}{{x}_{max} - {x}_{min}} \\ {\overline{Y}}_{mc} = ( {Y}_{mc} - \frac{{y}_{max} + {y}_{min}}{2} ) \frac{2 cos λ}{{y}_{max} - {y}_{min}} \qquad Eq . ( 1 )$$

wherein X_{mc} and Y_{mc} denote output values of the x-axis and y-axis of the geomagnetic sensor, respectively, and λ indicates a dip angle.

Meanwhile, at the tilt angle calculator 202, a tilt angle, namely, a roll angle and a pitch angle of the 2-axis geomagnetic sensor 101 are calculated based on tilt information measured by the 2-axis inclinometer, for example, acceleration information when a 2-axis accelerometer is selected as the 2-axis inclinometer.

Hereinafter, a normalization process where the 2-axis accelerometer is selected as the 2-axis inclinometer will be described. First, the mobile terminal 100 is put on the horizontal plane and then output values of the accelerometer are stored. At this time, it is assumed that acceleration values with respect to the x-axis and y-axis (the output values of the accelerometer) are x_{acc} (0) and y_{acc} (0), respectively.

Next, the mobile terminal 100 is rotated about +y axis by 90° or more. Here, “+” implies that a thumb of a user directs towards +y axis when his/her right hand grasps the y-axis. Among output values of the x-axis accelerometer measured during the above process, let the maximum value be called x_{acc} (g).

And then, the mobile terminal is again put on the horizontal plane and rotated about -x axis by 90° or more. In a similar way, let the maximum value out of output values of the y-axis accelerometer measured during the above process be called y_{acc} (g).

Then, the normalization of the output values of the 2-axis accelerometer, i.e., 2-axis accelerometer sensor data, is performed as follows:

$${\overline{X}}_{acc} = ( {X}_{acc} - {x}_{acc} ( 0 ) ) \frac{1}{{x}_{acc} ( g ) - {x}_{acc} ( 0 )} \\ {\overline{Y}}_{acc} = ( {Y}_{acc} - {y}_{acc} ( 0 ) ) \frac{1}{{y}_{acc} ( g ) - {y}_{acc} ( 0 )} \qquad Eq . ( 2 )$$

wherein X_{acc} and Y_{acc} denote output values of the x-axis and y-axis accelerometers, respectively, and the unit thereof after the normalization becomes a gravitational acceleration g.

The pitch angle θ and roll angle φ can be obtained by the following:

$$θ = {sin}^{- 1} ( \frac{{\overline{X}}_{acc}}{g} ) \\ Φ = {sin}^{- 1} ( - \frac{{\overline{Y}}_{acc}}{g cos θ} ) \qquad Eq . ( 3 )$$

On the other hand, the virtual axis (z-axis) geomagnetic data estimating unit 203 includes a data magnitude estimator 2031, a data sign estimator 2032 and a magnitude/sign combiner 2033.

A procedure of obtaining the virtual z-axis geomagnetic sensor data using the above equations in the virtual axis (z-axis) geomagnetic data estimating unit 203 will be described below.

First, the data magnitude estimator 2031 estimates a ‘magnitude’ of the virtual z-axis geomagnetic sensor data by using the 2-axis geomagnetic sensor data normalized through Eq. (1) above. Specifically, the magnitude of the virtual z-axis geomagnetic sensor data is estimated by employing the normalized 2-axis geomagnetic sensor data as follows:

| Z̅_{mc}|=\sqrt{1− X̅²_{mc}− Y̅²_{mc}} Eq. (4)

Thereafter, the data sign estimator 2032 estimates a sign of the virtual z-axis geomagnetic sensor data based on the normalized 2-axis geomagnetic sensor data described in Eq. (1) above, the tilt angle shown in Eq. (3) above and the dip angle (λ). More specifically, the sign of the virtual z-axis geomagnetic sensor data is estimated by the following:

S=sinλ X̅_{mc} sin θ− Y̅_{mc} cosθsin φ

S<0 sign( Z̅_{mc})=−

S≧0 sign( Z̅_{mc})=+ Eq. (5)

wherein φ and θ are the roll angle and the pitch angle calculated by the inclinometer, respectively, and their magnitudes are supposed to be less than 90°.

In the meantime, the magnitude/sign combiner 2033 combines the ‘magnitude’ estimated by the data magnitude estimator 2031 with the ‘sign’ estimated by the data sign estimator 2032 to lastly estimate virtual z-axis geomagnetic sensor data.

Finally, at the azimuth angle calculator 204, an azimuth angle is calculated based on the 2-axis geomagnetic sensor data normalized by the geomagnetic data normalizing unit 201, the tilt angle calculated by the tilt angle calculator 202 and the virtual geomagnetic data estimated by the geomagnetic data estimating unit 203, as defined in Eqs. (1) and (3) to (5) above.

To be more specific, the azimuth angle calculator 204 derives the azimuth angle, which the tilt angle error is compensated, by using the following:

$$φ = {tan}^{- 1} ( \frac{- {\overline{Y}}_{mc} cos φ + {\overline{Z}}_{mc} sin φ}{{\overline{X}}_{mc} cos θ + {\overline{Y}}_{mc} sin θsin φ + {\overline{Z}}_{mc} sin θcos φ} ) \qquad Eq . ( 6 )$$

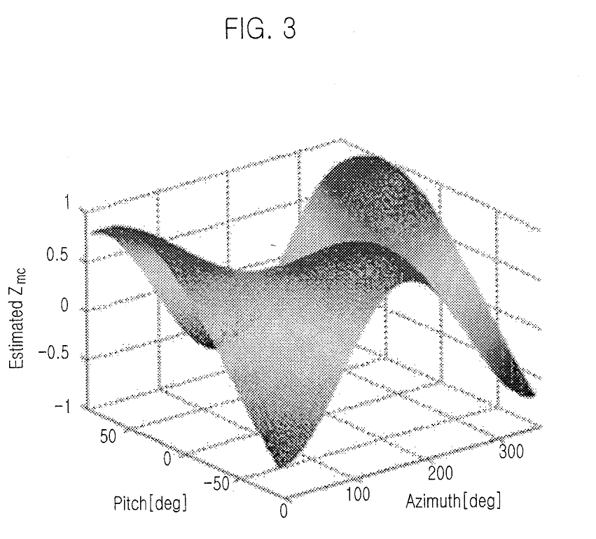

FIG. 3 describes z-axis geomagnetic sensor data according to the pitch angle and azimuth angle.

That is, FIG. 3 represents the virtual z-axis geomagnetic sensor data (Estimated Z_{mc}) with respect to the pitch angle and the azimuth angle, the magnitude of which is the same as Eq. (4) above and the sign of which is the same as Eq. (5) above.

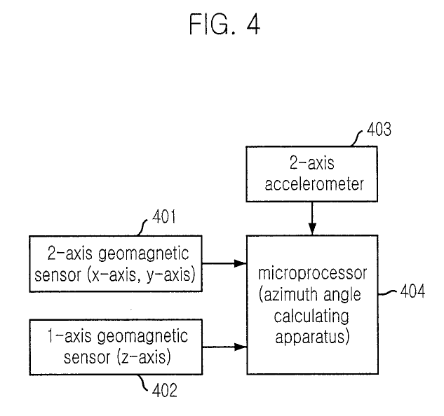

FIG. 4 shows a configuration of an experimental device for analyzing the performance of the azimuth angle calculating apparatus in accordance with an embodiment of the present invention. As shown in FIG. 4, the experimental device is provided with a 2-axis geomagnetic sensor 401, a 1-axis geomagnetic sensor 402, a 2-axis accelerometer 403 and a microprocessor (the azimuth angel calculating apparatus) 404.

Specifically, the 2-axis geomagnetic sensor 401 is arranged along the x-axis and y-axis, while the 1-axis geomagnetic sensor 402 is arranged along the z-axis for a comparison with the estimated z-axis geomagnetic sensor data. The 2-axis accelerometer 403 is arranged along the x-axis and y-axis for calculating the tilt angle.

The microprocessor 404 processes the sensor data, estimates the z-axis geomagnetic sensor signal and calculates the azimuth angle.

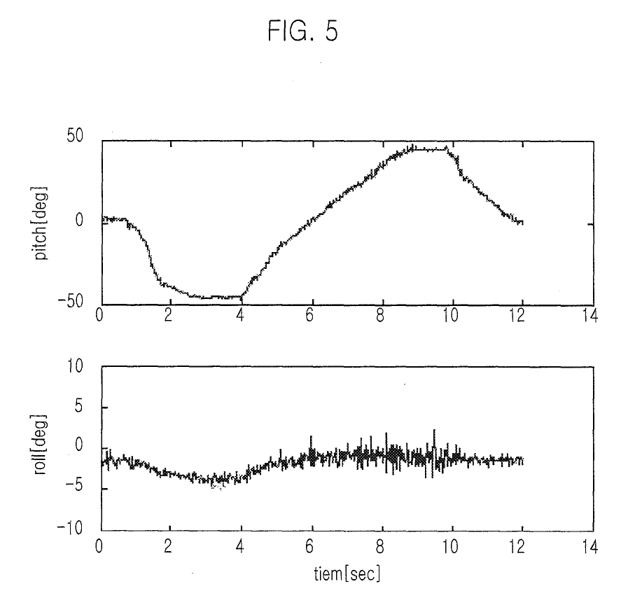

FIG. 5 describes a variable amount of the tilt angle used as an input variable in the experimental device shown in FIG. 4. Namely, FIG. 5 shows a variable amount of the tile angle used as an input variable in the experimental device, that is, the roll angle and pitch angle according to time.

As shown in FIG. 5, the experiment was mainly made while varying the pitch angle.

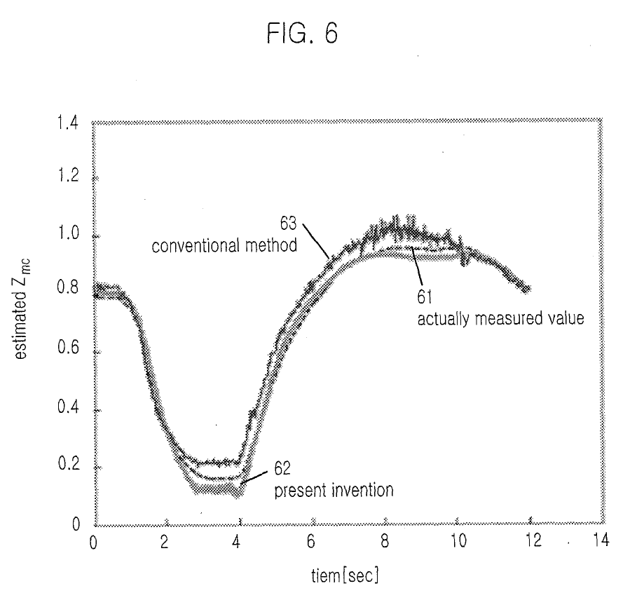

FIG. 6 shows the comparison result for estimation values of the z-axis geomagnetic sensor data between the conventional method and the present invention when no tilt angle error and dip angle error exist therein.

In FIG. 6, a dotted line 61 indicates z-axis geomagnetic sensor data actually measured by the 1-axis geomagnetic sensor 402 in the experimental device shown in FIG. 4.

Indicated by reference numerals 62 and 63 are the z-axis geomagnetic sensor data estimated according to the present invention and the conventional method disclosed in Korean Laid-open Publication No. 10-2005-0106553, respectively.

As shown in FIG. 6, in the absence of the tilt angle error and the dip angle error, it can be seen that the conventional method and the present invention show nearly similar experimental results with excellent performance.

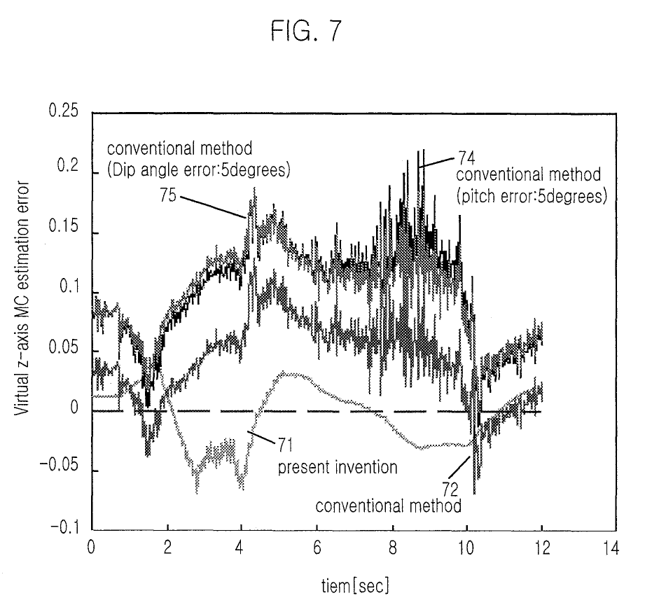

FIG. 7 describes the comparison results for estimation errors of the z-axis geomagnetic sensor data between the conventional method and the present invention when there are the tilt angle error and the dip angle error.

In FIG. 7, in the absence of the tilt angle error and the dip angle error, it can be known that the method 71 according to the present invention is slightly better than the conventional method 72.

Meanwhile, in the presence of the tilt angle error and the dip angle error, the method of the present invention is the same as the case without the tilt angle error and dip angle error. In such a case, however, it can be found that the estimation results 73 and 74 of the conventional method become larger in z-axis estimation errors. Designated by reference numerals 73 and 74 are the z-axis estimation errors when the dip and pitch angle errors are 5°, respectively.

From FIGS. 6 and 7, it can be confirmed that the present invention shows better performance than the conventional method.

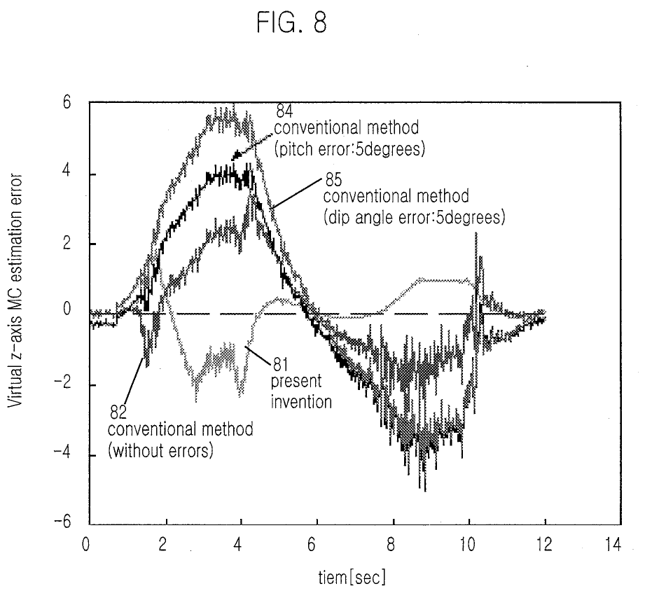

FIG. 8 exemplifies the comparison result for azimuth errors between the conventional method and the present invention.

In FIG. 8, reference numeral 81 indicates azimuth information calculated by the z-axis geomagnetic sensor data estimated in accordance with the present invention. Reference numerals 82 through 84 indicate azimuth information calculated according to the conventional method, wherein reference numeral 82 is about when no dip and tilt angle errors exist, reference numeral 83 is about when the dip angle error is 5°, and reference numeral 84 is about when the pitch angle error is 5°.

From FIG. 8, it can be seen that using the z-axis geomagnetic sensor data estimated in accordance with the present invention shows less error and thus better performance than using the z-axis geomagnetic sensor data estimated by the conventional method.

While the present invention has been described with respect to certain preferred embodiments, it will be apparent to those skilled in the art that various changes and modifications may be made without departing from the scope of the invention as defined in the following claims.

What is claimed is:

1. An apparatus for estimating virtual axis geomagnetic data using a 2-axis geomagnetic sensor and an inclinometer, comprising:
a geomagnetic data normalizing means for normalizing 2-axis geomagnetic data measured by the 2-axis geomagnetic sensor;
a tilt angle calculating means for calculating a tilt angle of the 2-axis geomagnetic sensor by using tilt information measured by the inclinometer; and
a virtual axis geomagnetic data estimating means for determining a magnitude of virtual geomagnetic data with respect to a virtual axis by using the normalized 2-axis geomagnetic data, and determining a sign of the virtual geomagnetic data based on the normalized 2-axis geomagnetic data, the calculated tilt angle and a dip angle to thereby estimate the virtual axis geomagnetic data.

2. The apparatus as recited in claim 1, wherein if maximum values and minimum values of the x-axis and y-axis geomagnetic data measured during rotation of a mobile terminal incorporating the 2-axis geomagnetic sensor about z-axis are [xₘᵢₙ, Xₘₐₓ] and [Yₘᵢₙ, Yₘₐₓ], respectively, in case of measuring geomagnetic data with respect to the x-axis and y-axis in the 2-axis geomagnetic sensor, the geomagnetic data normalizing means derives normalized geomagnetic data with respect to the x-axis and y-axis by using the following:
$${\overline{X}}_{mc} = ( {X}_{mc} - \frac{{x}_{max} + {x}_{min}}{2} ) \frac{2 cos λ}{{x}_{max} - {x}_{min}} \\ {\overline{Y}}_{mc} = ( {Y}_{mc} - \frac{{y}_{max} + {y}_{min}}{2} ) \frac{2 cos λ}{{y}_{max} - {y}_{min}} \qquad Eq . ( 1 )$$
wherein X_{mc} and Y_{mc} denote geomagnetic data measured by the 2-axis geomagnetic sensor, and X indicates the dip angle.

3. The apparatus as recited in claim 2, wherein if the inclinometer is a 2-axis acceleration sensor, the tile angel calculating means calculates a pitch angle θ and a roll angle φ by using acceleration information provided by the 2-axis acceleration sensor.

4. The apparatus as recited in claim 3, wherein the virtual axis geomagnetic estimating means includes:
a data magnitude estimator for determining a magnitude of virtual z-axis geomagnetic data based on the 2-axis geomagnetic data normalized by the following equation (2);
a data sign estimator for determining a sign of the virtual z-axis geomagnetic data by using the following equation (3); and
a virtual axis geomagnetic estimator for combining the data magnitude determined by the data magnitude estimator with the data sign determined by the data sign estimator to thereby estimate the virtual z-axis geomagnetic data,
S=sinλ X̅_{mc} sin θ− Y̅_{mc} cosθsin φ
if S<0 sign( Z̅_{mc})=−
if S≧0 sign( Z̅_{mc})=+ Eq. (5)
wherein λ indicates the dip angle, and θ and φ are the pitch angle and the roll angle, respectively.

5. A method of estimating virtual z-axis geomagnetic sensor data in a mobile terminal incorporating a 2-axis (x-axis and y-axis) geomagnetic sensor and an inclinometer, comprising the steps of:
measuring, at the 2-axis geomagnetic sensor, x-axis and y-axis directional geomagnetic data (2-axis geomagnetic data) when the mobile terminal rotates about z-axis;
normalizing the 2-axis geomagnetic data by using maximum and minimum values among the measured geomagnetic data, and a dip angle;
calculating a pitch angle and a roll angle of the 2-axis geomagnetic sensor based on tilt information measured by the inclinometer;
estimating a magnitude of the virtual z-axis geomagnetic data from the normalized 2-axis geomagnetic data; and
estimating a sign of the virtual z-axis geomagnetic data depending on the normalized 2-axis geomagnetic data, the dip angle, and the pitch and roll angles obtained at the calculating step.

6. The method as recited in claim 5, wherein if maximum values and minimum values of x-axis and y-axis geomagnetic data measured at the 2-axis geomagnetic data measuring step are [xₘᵢₙ, xₘₐₓ] and [yₘᵢₙ, yₘₐₓ], respectively, the data normalizing step derives normalized geomagnetic data with respect to the x-axis and y-axis by using the following:
$${\overline{X}}_{mc} = ( {X}_{mc} - \frac{{x}_{max} + {x}_{min}}{2} ) \frac{2 cos λ}{{x}_{max} - {x}_{min}} \\ {\overline{Y}}_{mc} = ( {Y}_{mc} - \frac{{y}_{max} + {y}_{min}}{2} ) \frac{2 cos λ}{{y}_{max} - {y}_{min}} \qquad Eq . ( 1 )$$
wherein X_{mc} and Y_{mc} denote geomagnetic data measured by the 2-axis geomagnetic sensor, and X indicates the dip angle.

7. The method as recited in claim 6, wherein the data magnitude estimating step determines a magnitude of the virtual z-axis geomagnetic data based on the 2-axis geomagnetic data normalized as:

| Z̅_{mc}|=\sqrt{1− X̅²_{mc}− Y̅²_{mc}} Eq. (2)

8. The method as recited in claim 6, wherein the data sign estimating step determines a sign of the virtual z-axis geomagnetic data by using the following:
S=sinλ X̅_{mc} sin θ− Y̅_{mc} cosθsin φ
S<0 sign( Z̅_{mc})=−
S≧0 sign( Z̅_{mc})=+ Eq. (5)
wherein λ indicates the dip angle, and θ and φ are the pitch angle and the roll angle, respectively.

9. An apparatus for calculating an azimuth angle using a 2-axis geomagnetic sensor, comprising:
a virtual axis geomagnetic data estimating means for determining a magnitude of geomagnetic data with respect to a virtual axis by using 2-axis geomagnetic data measured and normalized by the 2-axis geomagnetic sensor, and determining a sign of the virtual axis geomagnetic data based on the normalized 2-axis geomagnetic data, a tilt angle and a dip angle of the 2-axis geomagnetic sensor to thereby estimate the virtual axis geomagnetic data; and
an azimuth angle calculating means for calculating an azimuth angle by using the normalized 2-axis geomagnetic data, the tilt angle, and the virtual axis geomagnetic data estimated by the virtual axis geomagnetic data estimating means.

10. The apparatus as recited in claim 9, wherein the virtual axis geomagnetic estimating means includes:
a data magnitude estimator for determining a magnitude of virtual z-axis geomagnetic data based on the 2-axis geomagnetic data normalized by the following equation (2);
a data sign estimator for determining a sign of virtual z-axis geomagnetic data by using the following equation (3); and
a virtual axis geomagnetic estimator for combining the data magnitude determined by the data magnitude estimator with the data sign determined by the data sign estimator to thereby estimate the virtual z-axis data,
S=sinλ X̅_{mc} sin θ− Y̅_{mc} cosθsin φ
S<0 sign( Z̅_{mc})=−
S≧0 sign( Z̅_{mc})=+ Eq. (5)
wherein λ indicates the dip angle, and θ and φ are the pitch angle and the roll angle, respectively.
